(19) United States
(12) Patent Application Publication
(10) Pub. No.: US 2009/0102635 A1
(43) Pub. Date: Apr. 23, 2009

(54) METHOD OF MANAGING A NETWORK OF SENSORS, A SENSOR NETWORK, AND A VEHICLE PROVIDED WITH SUCH A NETWORK

(75) Inventors: Sebastien Massoni, Clermont-Ferrand (FR); Maxime Rolland, Pessat-Villeneuve (FR)

Correspondence Address: FITZPATRICK CELLA HARPER & SCINTO, 30 ROCKEFELLER PLAZA, NEW YORK, NY, 10112, US

(73) Assignee: Michelin Recherche et Technique S.A., Granges-Paccot (CH)

(21) Appl. No.: 12/256,065

(22) Filed: Oct. 22, 2008

(30) Foreign Application Priority Data
Oct. 23, 2007 (FR) 0758499

(51) Int. Cl. B60C 23/00

(52) U.S. Cl. 340/443

(57) ABSTRACT

The network of sensors comprises at least two nodes, each forming a measurement unit including a sensor, and a node forming a processor unit to which the measurement units are connected. Each measurement unit is designed to acquire measurements and to transmit a measurement that is a function of said measurements to the processor unit. During the method of managing the network, the measurement acquisition sequences performed by the measurement units are synchronized with one another by means of a synchronization signal sent by the processor unit to each of the measurement units.

### FIELD OF THE INVENTION

The present invention relates to the technical field of monitoring tire pressure.

The invention applies particularly, but not exclusively, to monitoring tire pressures of a tractor or a trailer of a heavy goods type vehicle, in particular by using inclinometers.

Below, the term “pressure” is used to designate the internal pressure of a tire defined as the force per unit area exerted against an internal surface of the tire by the gas contained in the tire

### BACKGROUND OF THE INVENTION

In a vehicle provided with wheels fitted with respective tires, it is known to monitor the pressure of the tires by means of a network of pressure sensors.

In particular, it is known to make use of a network of the type comprising:
at least two nodes, each forming a unit for measuring pressure directly; and
a node forming a processor unit to which the measurement units are connected.

Each measurement unit is generally arranged on the rim of a corresponding wheel. The processor unit is generally arranged on the chassis of the vehicle.

Each measurement unit includes a sensor and a radio communications unit having transmission means suitable for transmitting a measurement signal to the processor unit.

The processor unit includes a radio communications unit having reception means suitable for receiving the measurement signals transmitted by the measurement units. The processor unit makes use in particular of calculation means to process each measurement signal by comparing it with a threshold. The result of the comparison serves to reveal a tire with insufficient pressure, if any.

The management of a network of sensors of the above-specified type is generally performed by allowing each measurement unit to transmit measurement signals to the processor unit autonomously and independently of the other measurement units.

That type of sensor network management is inappropriate when it is desired to monitor tire pressures without having recourse to direct measurements of the pressure in each tire. Under such circumstances, it is necessary to make comparisons between the information coming from different ones of the sensors. The information that is compared must relate to appropriate instants, which means that it is not possible for the measurement units to be managed in mutually independent manner.

### OBJECT AND SUMMARY OF THE INVENTION

The object of the present invention is specifically to provide an optimized method of managing a network of sensors for monitoring tire pressures without having recourse to direct measurements of the pressure in each tire.

To this end, the invention provides a method of managing a network of sensors, the network comprising:
at least two nodes, each forming a measurement unit including a sensor; and
a node forming a processor unit to which the measurement units are connected;

each measurement unit being designed to acquire measurements and to transmit to the processor unit a signal that is a function of said measurements, and referred to as a measurement signal; measurement acquisition sequences performed by the measurement units are mutually synchronized by means of a synchronization signal transmitted by the processor unit to each of the measurement units.

The synchronization signal serves to trigger each acquisition sequence in each measurement unit simultaneously. Thus, each measurement of each acquisition sequence is taken substantially simultaneously by each of the measurement units of the network. The signals transmitted to the processor unit then comprise acquisition sequences that are mutually synchronized.

Specifically, the method of the invention is particularly advantageous when it is necessary to make comparisons between measurements taken by different measurement units. By synchronizing the measurement sequences with one another, it is possible to compare these measurements without any need to take account of possible time offsets.

According to an optional characteristic of the method of the invention, a synchronization signal is transmitted after the processor unit has received measurement signals transmitted by all of the measurement units.

This serves to avoid triggering a new acquisition sequence without previously receiving measurements signals form all of the measurement units.

Optionally, a synchronization signal is transmitted in the event of the processor unit not receiving an expected measurement signal from a measurement unit within a predetermined waiting delay.

This avoids the processor unit waiting for longer than the waiting delay to receive signals from all of the measurement units. It is possible that the processor unit cannot receive an expected measurement signal. This could occur, for example, as a result of defective acquisition by a measurement unit such that the measurement signal is not transmitted. This can also occur in the event of the measurement signal suffering faulty transmission to the processor unit.

Advantageously, after an earlier synchronization signal has been transmitted before said synchronization signal, the waiting delay begins after the transmission of the earlier synchronization signal, when the processor unit receives a measurement signal that is preferably the first signal it receives after transmission of the earlier synchronization signal.

According to other optional characteristics of the method of the invention:
at least one measurement signal is represented by a vector having a plurality of coordinates and referred to as a measurement vector;
each coordinate of the measurement vector is the image obtained by applying a function to n₀ measurements, n₀ being a non-zero integer and the function preferably being an arithmetic mean of the n₀ measurements;
each measurement acquisition sequence comprises nₑ steps of acquiring n₀ measurements alternating with nₑ steps of calculating the image of said n₀ measurements by applying the function, where nₑ is a non-zero integer;
the measurement signal is transmitted after coordinates have been stacked in a stack forming part of storage means of the measurement unit and after the stack reaches a number of coordinates that is equal to the number of coordinates of the vector; and
the processor unit calculates differences between the coordinates of two measurement vectors transmitted by two distinct respective measurement units.

The invention also provides a network of sensors, the network being of the type comprising:
at least two nodes, each forming a measurement unit including a sensor; and
a node forming a processor unit to which the measurement units are connected;

each measurement unit including a communications unit having transmission means suitable for transmitting at least one measurement signal, the processor unit including a communications unit including reception means suitable for receiving each of the measurement signals as transmitted by each measurement unit; the processor unit includes synchronization means for synchronizing measurement acquisition sequences by the measurement units, the communications unit of the processor unit including transmission means suitable for transmitting a synchronization signal, and the communications unit of each measurement unit including reception means suitable for receiving the synchronization signal.

In such a network, each communications unit of the processor unit and of each measurement unit operates both in transmission and in reception.

According to optional characteristics of the network of the invention:
the communications unit of the processor unit is formed by a radio communications module suitable for operating an application of a standard of the IEEE 802.15.4 type; and
the communications unit of each measurement unit is formed by a radio communications module suitable for operating in application of a standard of the IEEE 802.15.4 type.

The IEEE 802.15.4 type standard uses a 2.45 gigahertz (GHz) frequency band that is suitable for use with antennas of small size. The module is thus relatively compact. In addition, the IEEE 802.15.4 standard is particularly adapted for use with networks of sensors and thus with the invention. Furthermore, communications modules operating in application of this standard are inexpensive, they present relatively low energy consumption, and they enable reliable communication to be obtained in a very noisy environment.

According to other optional characteristics of the invention of the invention:
the communications unit of the processor unit is formed by a wired-bus communications module suitable for operating with a CAN type protocol; and
the communications unit of each measurement unit is formed by a wired-bus communications module suitable for operating in application of a CAN type protocol.

“CAN” is an abbreviation for controller area network. The CAN type protocol applies to so-called “field” networks that must be capable of operating in a severe environment such as in a heavy goods type vehicle. It enables networks to be implemented that are suitable for operating in real time with a high level of reliability, transmission taking place physically over a wired connection, e.g. over a differential pair.

According to other optional characteristics of the network of the invention:
each measurement unit includes a calculation unit, preferably, a microcontroller;
the synchronization means comprise a microcontroller;
the processor unit includes a calculation unit, preferably, a microcontroller;
the processor unit comprises a microcontroller constituting both the microcontroller of the synchronization means and the microcontroller of the calculation unit of the processor unit; and
the network includes a microcontroller forming both the microcontroller of the processor unit and the microcontroller of a measurement unit.

The invention also provides a vehicle provided with a network as defined above for monitoring tire pressures of the vehicle.

Advantageously, each sensor comprises an inclinometer carried by an axle of the vehicle and serving to measure an angle of inclination of the axle axis relative to a direction about an inclination axis that is parallel to said direction, which inclinometer is preferably of the electrolytic type.

Such a network of sensors for monitoring tire pressures of the vehicle provides improved communication between each measurement unit and the processor unit. In a vehicle provided with a network of sensors for measuring pressure directly, each sensor is mounted in a rotary assembly comprising a wheel rim and a tire. The tire generally comprises a carcass including metal plies. These plies form a shield against electromagnetic waves and degrade communication between each measurement unit and the processor unit. In the invention, each inclinometer is carried by an axle of the vehicle, so communication therewith is of better quality.

Furthermore, each sensor is not mounted in a rotary assembly, so it is very easy to install a wired connection between measurement unit and the processor unit.

Furthermore, installing a network of the invention does not require the balance of each rotary assembly to be corrected. With a vehicle having a conventional network of sensors for measuring pressure directly, each measurement unit is mounted in a rotary assembly. Each measurement unit thus forms an off-center mass that needs to be compensated by adding a balancing mass. The invention avoids the need for a balancing mass.

Optionally, the vehicle includes an electricity source suitable for powering, amongst other members of the vehicle, at least one of the measurement units.

By way of example, the source comprises a battery for powering members such as signaling lights of the vehicle, electrical equipment of the cabin, etc. The battery is generally connected to recharger means. The source thus enables the operating lifetime of a conventional network of sensors to be lengthened. In a vehicle that is provided with a network of sensors that measure pressure directly, each measurement unit generally includes a battery that powers the measurement unit electrically. Since the mass of the battery must be relatively small (for the above-mentioned reasons of balancing the rotary assembly), the operating lifetime of the network is shortened correspondingly by reducing the mass of the battery. In the invention, the source makes it possible for each measurement unit to be powered, a priori without any time limit.

Furthermore, the battery connected to the recharger means enables each measurement unit to be powered continuously so as to enable it to receive the synchronization signal. Since each measurement unit must be capable of receiving a synchronization signal on a permanent basis, it needs to be powered continuously.

Advantageously, the vehicle includes a box suitable for fitting on an axle of the vehicle, the box containing the processor unit and a measurement unit.

### BRIEF DESCRIPTION OF THE DRAWINGS

The invention can be better understood on reading the following description given purely by way of non-limiting example and made with reference to the drawings, in which:

FIG. 1 is a diagrammatic view in an X,Z plane of a heavy goods type vehicle provided with two sensor networks in accordance with first and second embodiments of the invention for monitoring tire pressures;

FIG. 2 is a diagrammatic view in an X,Y plane of three axles of a tractor of the FIG. 1 vehicle provided with a network in accordance with the first embodiment of the invention;

FIG. 3 is a diagrammatic perspective view of a box including a measurement unit of a sensor network of the invention;

FIG. 4 is a diagrammatic perspective view of a box including a processor unit of a sensor network of the invention;

FIG. 5 is a graph showing diagrammatically a plurality of successive measurement sequences performed by the network of the first embodiment;

FIG. 6 is an enlargement of one of the measurement sequences of FIG. 5;

FIG. 7 is a detail view in the X,Z plane of two axles of a trailer of the FIG. 1 vehicle provided with a network in accordance with the second embodiment of the invention;

FIG. 8 is a graph showing diagrammatically a plurality of successive measurement sequences performed by the network of the second embodiment;

FIG. 9 is a view similar to FIG. 1 in which the vehicle is provided with two sensor networks in accordance with third and fourth embodiments of the invention; and

FIG. 10 is a diagrammatic perspective view of a common box including both a measurement unit and a processor unit for networks of the third and fourth embodiments of the invention.

### MORE DETAILED DESCRIPTION

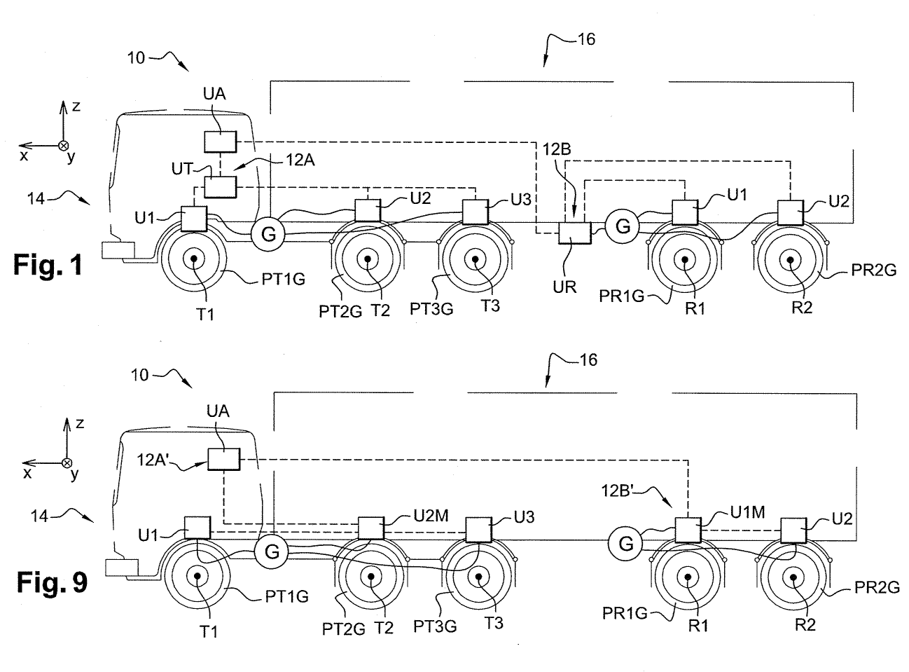

In FIGS. 1, 2, 7, and 9, there can be seen mutually-orthogonal axes X, Y, and Z corresponding to the usual longitudinal (X), transverse (Y), and vertical (Z) orientations of a vehicle.

FIG. 1 shows a heavy goods type vehicle 10 provided with two networks respectively in accordance with first and second embodiments of the invention and given respective references 12A and 12B.

The vehicle 10 comprises a tractor 14 provided with a network 12A of sensors in accordance with the first embodiment, and a trailer 16 fitted with a network 12B of sensors in accordance with the second embodiment.

As shown in FIGS. 1 and 2, the tractor 14 has first, second, and third axles given respective references T1, T2, and T3. None of these three axles are coupled together in tandem.

The first axle T1 carries a first pair of transversely-opposite wheels. The right and left wheels carried by the axle T1 are given respective references T1D and T1G. Each wheel T1D, T1G is fitted with a tire PT1D, PT1G. The axle T1 defines an axis AT1 referred to as the first axle axis. This axis AT1 passes through the centers of the wheels T1D and T1G of the first pair.

Elements relating to the second and third axles T2, T3 are given references that can be deduced mutatis mutandis from the references of elements relating to the first axle T1 by replacing mentions “T1” in the references by “T2” or “T3”, as appropriate. The axes of the axles AT1, AT2, and AT3 are substantially parallel in pairs.

As shown in FIGS. 1 and 7, the trailer 16 has first and second axles given respective references R1 and R2. These two axles R1 and R2 are not coupled together.

The first axle R1 carries a first pair of transversely-opposite wheels. The right and left wheels carried by the axle R1 are given respective references R1D and R1G. Each wheel R1D, R1G is fitted with a respective tire PR1D, PR1G. The axle R1 defines an axis AR1 referred to as the first axle axis. This axis AR1 passes through the centers of the wheels R1D and R1G of the first pair.

The elements relating to the second axle R2 are given references that can be deduced mutatis mutandis from the references for the elements relating to the first axle R1 by replacing the mention “R1” in the references by “R2”, where appropriate. The axles RT1 and RT2 are substantially mutually parallel.

The network 12A of the first embodiment of the invention (network of the tractor 14) is described below.

The network 12A of the first embodiment of the invention comprises first, second, and third nodes forming respective first, second, and third measurement units U1, U2, and U3. The network 12A also has a node forming a processor unit UT to which each of the measurement units U1, U2, and U3 is connected. In addition, the network 12A has a display unit UA connected to the processor unit UT. Specifically, the display unit UA is connected to the processor unit UT, and the processor unit UT is connected to each of the measurement units via radio connections using a 2.45 GHz band. The measurement units U1, U2, and U3, the processor unit UT, and the display unit UA are powered electrically by an electricity source G of the vehicle 10. This source G also delivers electricity to other members of the vehicle 10, e.g. the driver's cab or the signal lights of the vehicle 10. By way of example, the source G is constituted by a battery connected to recharger means.

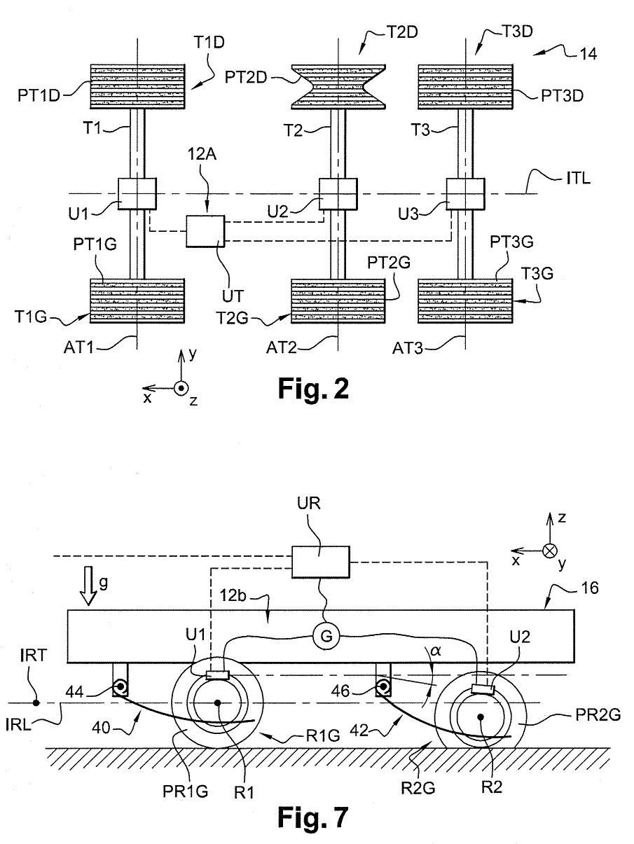

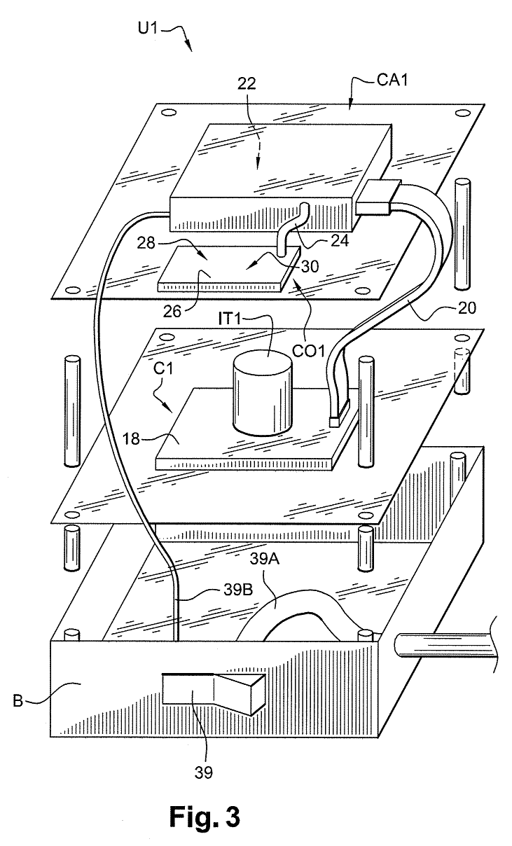

Each measurement unit U1, U2, and U3 is carried by a respective one of the first, second, and third axles T1, T2, and T3. With reference to FIG. 3, where only the unit U1 is shown, it can be seen that each measurement unit U1, U2, or U3 comprises a generally rectangular box B including a sensor C1, C2, or C3 specifically comprising an inclinometer IT1, IT2, or IT3, a communications unit CO1, CO2, or CO3, and a calculation unit CA1, CA2, or CA3. Each unit U1, U2, or U3 is suitable for producing a signal S1, S2, or S3 as a function of the angles measured by each of the inclinometers IT1, IT2, or IT3, which signal is referred to as the measurement signal.

Each inclinometer IT1, IT2, and IT3 is designed to measure, relative to a first direction, the angle of inclination of the first, second, or third axle AT1, AT2, or AT3, respectively, about an inclination axis ITL parallel to said first direction. In the example shown in FIGS. 1 and 3, the first direction corresponds substantially to the longitudinal direction of the tractor, parallel to the X axis. The inclinometers IT1, IT2, and IT3 are preferably of the electrolytic type. Each sensor also includes a signal conditioner 18 suitable for shaping a signal on the basis of angle measurements made by the corresponding inclinometer IT1, IT2, or IT3.

Each sensor is connected to the calculation unit CA1, CA2, or CA3 via a ribbon 20. Each calculation unit CA1, CA2, or CA3 includes, amongst other things, a microcontroller 22.

Specifically, each calculation unit CA1, CA2, or CA3 is suitable for calculating a history of an inclination angle over a given time interval, referred to as an inclination history. The angle of inclination is taken from the angles of inclination of the first, second, and third axle axes AT1, AT2, and AT3 about the inclination axis ITL that is parallel to the longitudinal direction of the vehicle. Each inclination history corresponding to each angle of inclination of the first, second, and third axle axes AT1, AT2, and AT3 is given a respective reference VL1, VL2, and VL3.

Each calculation unit CA1, CA2, and CA3 is connected to a respective communications unit CO1, CO2, or CO3 via a respective transmission ribbon 24. Specifically, each communications unit CO1, CO2, and CO3 is formed by a radio communications module 26 suitable for operating in compliance with a standard of the IEEE 802.15.4 type. Each communications unit has transmission means 28 and reception means 30. The module 26 is preferably suitable for transmitting electromagnetic signals at a power of less than 1 milliwatt (mW). By means of its communications module 26, each measurement unit U1, U2, and U3 is suitable for transmitting its measurement signal to the processor unit UT.

In a variant, the communications units CO1, CO2, CO3 of each measurement unit is formed by a wired bus communications module suitable for operating in application of a CAN type protocol. Optionally, the communications unit can encode the information generated by the corresponding calculation unit into CAN type signals. Such a module is known as a CAN driver. Each communications unit CO1, CO2, and CO3 is then connected to the processor unit UT via a wire connection, e.g. a differential pair.

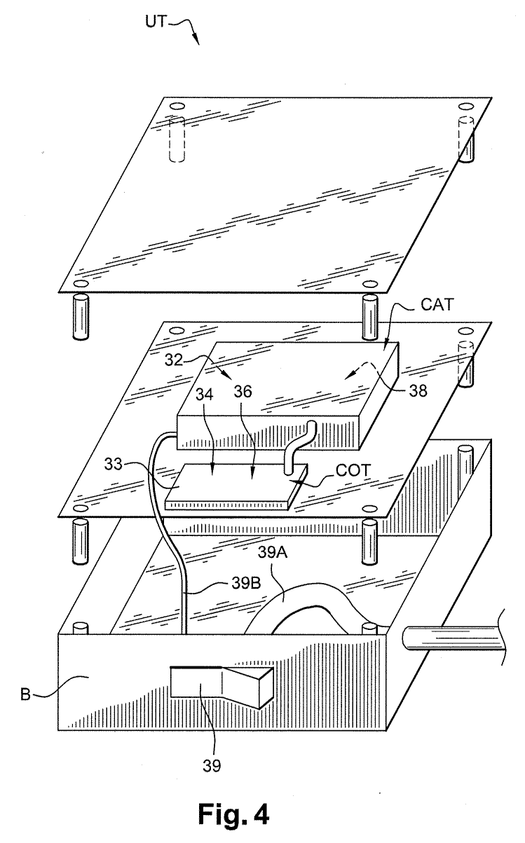

As shown in FIG. 4, the processor unit UT comprises a communications unit COT, a calculation unit CAT, and means 32 for synchronizing acquisition sequences of angle measurements performed by the measurement units U1, U2, and U3.

The communications unit COT is formed by a radio communications module 33 suitable for operating in application of a standard of the IEEE 802.15.4 type. The communications unit COT comprises transmission means 34 suitable for transmitting a synchronizing signal S, and reception means 36 suitable for receiving each measurement signal as transmitted by each of the measurement units U1, U2, and U3. The reception means 30 of the communications units CO1, CO2, and CO3 of each of the measurement units U1, U2, and U3 are suitable for receiving the synchronization signal S. The module 33 is preferably suitable for transmitting electromagnetic signals at a power greater than 50 mW.

In a variant, the communications unit COT is formed by a wired-bus communications module suitable for operating in application of a CAN type protocol. Optionally, the communications module may be of the CAN driver type. The calculation unit CAT comprises a microprocessor 38 suitable for processing the measurement signals S1, S2, and S3 from each of the measurement units U1, U2, and U3.

The synchronization means 32 comprise a microcontroller formed by the microcontroller 38 of the CAT calculation unit. Thus, the microprocessor 38 is common to the synchronization means 32 and to the CAT calculation unit.

The CAT calculation unit of the processor unit UT is suitable for calculating an indicator referred to as a “deflection” indicator on the basis of at least two inclination histories.

Each unit U1, U2, U3, and UT also includes an on/off switch 39 concerning the supply of power thereto. In the example described, the switch 39 is connected both to the source G and to the microcontroller 38 of the corresponding unit respectively by conductors 39A and 39B.

The network 12A of the tractor 14 serves to monitor the pressure in the tires of the tractor 14 in application of a monitoring method having main steps as described below.

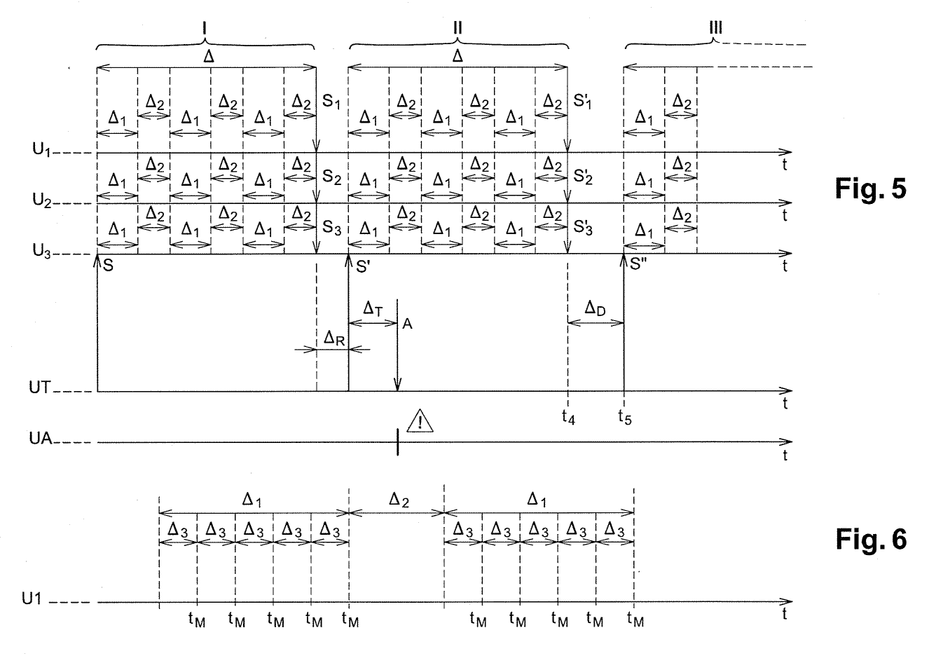

FIG. 5 is a diagram representing the operations performed by the measurement units U1, U2, U3, the processor unit UT, and the display unit UA of the network 12A, and also showing the signal exchanges implemented between these various units over time. More precisely, first and second complete acquisition sequences I and II are shown together with part of a third acquisition sequence III. The sequences I, II, and III follow one another in that order.

The first, second, and third inclination histories VL1, VL2, and VL3 are calculated relative to the longitudinal direction.

The first inclination history VL1 is the history of the inclination of the angle of the first axle axis AT1 relative to the longitudinal direction. The second inclination history VL2 is the inclination history of the angle of the second axle axis AT2 relative to the longitudinal direction. The third inclination history VL3 is the history of the inclination of the angle of the third axle axis AT3 relative to the longitudinal, direction.

The first, second, and third measurement units U1, U2, and U3 acquire respective angle measurements relative to the longitudinal direction of the first, second, and third axle axes AT1, AT2, and AT3.

As shown in FIG. 5, each measurement sequence I, II, and III has a duration Δ and comprises nₑ steps of calculating n₀ measurements in alternation with nₑ steps of calculating images of these n₀ measurements by applying a function F. n₀ and nₑ are non-zero integers. By way of example, the function F is an arithmetic mean of the n₀ measurements. In the example shown, nₑ is equal to three and n₀ is equal to five.

Specifically, each measurement step is performed over a time interval Δ₁ and each acquisition step over a time interval Δ₂. During the time interval Δ₁ of each measurement step, n₀ measurements are made of the angle of each axle axis AT1, AT2, and AT3 relative to the longitudinal direction. The measurements within a given measurement step are spaced apart from one another by a time interval Δ₃ that is constant, as shown in FIG. 6.

Each image of the n₀ measurements obtained by applying the function F forms one coordinate of a vector V referred to as a “measurement” vector. Each vector V forms the inclination history VL1, VL2, and VL3 for each of the inclination angles of the first, second, and third axle axes AT1, AT2, and AT3. Each of the coordinates of the vector V is stacked in storage means of the processor unit. Specifically, the storage means are included in each of the calculation units CA1, CA2, and CA3 of each of the measurement units U1, U2, and U3. When the stack reaches a number n₁ of coordinates equal to the number n₁ of coordinates in the vector V, specifically three, the measurement signal S1, S2, S3 is transmitted to the processor unit UT. Each measurement signal S1, S2, S3 is thus represented by the vector V in which each coordinate corresponds to a respective step of acquiring n₀ angle measurements.

The processor unit UT then receives each measurement signal S1, S2, and S3 from each of the measurement units U1, U2, and U3. As shown by the first measurement sequence I, the processor unit UT receives each measurement signal S1, S2, and S3 over a time interval Δ_{R}.

The network 12A of the tractor 14 is managed in application of the method of the invention. Thus, with reference to FIG. 5, after the unit UT has received the signals S1, S2, and S3 as transmitted by the set of units U1, U2, and U3, the synchronization signal S′ is transmitted to each of the measurement units U1, U2, and U3. The measurement acquisition sequences carried out by the measurement units U1, U2, and U3 are synchronized with one another by means of the signal S′ transmitted by the unit UT. When the signal S′ is received in each measurement unit U1, U2, or U3, the unit U1, U2, or U3 begins the second measurement sequence II.

In addition, after the unit UT has received the signals S, S2, and S3 as transmitted by the set of units U1, U2, and U3, the processor unit UT operates over a time interval Δ_{T} to calculate the first, second, and third deflection indicators relative to the first direction, given respective references λ_{T1,2}, λ_{T2,3}, and λ_{T1,3}, this being done respectively from the first and second inclination histories VL1 and VL2, from the second and third inclination histories VL2 and VL3, and from the first and third inclination histories VL1 and VL3.

To do this, the first, second, and third deflection vectors relative to the longitudinal direction, given respective references V_{T1,2}, V_{T2,3}, and V_{T1,3} are calculated respectively from the first and second inclination histories VL1 and VL2, from the second and third inclination histories VL2 and VL3, and from the first and third inclination histories VL1 and VL3.

Specifically, the processor unit UT calculates each coordinate of each deflection vector V_{T1,2}, V_{T2,3}, and V_{T1,3} by calculating the differences between the respective coordinates of the two measurement vectors as transmitted by the two corresponding distinct measurement units. In general, V_{Ti,j} is used to designate the deflection vector calculated from the inclination histories relative to the longitudinal direction for the angles of the axle axes i and j. In the example described, each vector V_{T1,2}, V_{T2,3}, and V_{T1,3} thus corresponds to n₁ coordinates, and specifically to three coordinates.

During measurement sequences prior to the first measurement sequence, prior first, second, and third deflection vectors VE_{T1,2}, VE_{T2,3}, and VE_{T1,3} were stored. Each of the vectors VE_{T1,2}, VE_{T2,3}, and VE_{T1,3} has n₂ coordinates, where n₂ is a multiple of n₁ and greater than n₁, e.g. being equal to thirty. As soon as the calculation unit CAT has calculated the vectors V_{T1,2}, V_{T2,3}, and V_{T1,3}, the calculation unit CAT deletes the oldest n₁ coordinates from each prior deflection vector VE_{T1,2}, VE_{T2,3}, and VE_{T1,3}, and adds the n₁ coordinates as calculated during the first measurement sequence I. In this way, new deflection vectors VE_{T1,2}, VE_{T2,3}, and VE_{T1,3} are calculated that have been enriched with the most recent coordinates.

Thereafter, a non-zero integer number n₃ of coordinates is removed from each enriched deflector vector VE_{T1,2}, VE_{T2,3}, and VE_{T1,3}. In the example described, these n₃ removed coordinates correspond to the coordinates having values that are the smallest and the greatest. This number n₃ is proportional to the number n₂. Specifically, the processor unit removes 20% of the n₂ coordinates, i.e. the 10% of coordinates having the smallest value and the 10% of coordinates having the greatest value. This produces three culled deflection vectors T_{T1,2}, T_{T2,3}, and T_{T1,3}, each having n₄ coordinates, and specifically twenty-four coordinates.

In a variant, it is possible to use other filters in order to obtain culled deflection vectors T_{T1,2}, T_{T2,3}, and T_{T1,3} each having n₄ coordinates from the enriched deflection vectors VE_{T1,2}, VE_{T2,3}, and VE_{T1,3} each having n₂ coordinates.

Thereafter, the calculation unit CAT is used to calculate the arithmetic means M_{T1,2}, M_{T2,3}, and M_{T1,3} of the n₄ coordinates in each culled deflection vector T_{T1,2}, T_{T2,3}, and T_{T1,3}.

Thereafter, the calculation unit CAT is used to calculate each deflection indicator λ_{T1,2}, λ_{T2,3}, and λ_{T1,3} by calculating the difference between each arithmetic means M_{T1,2}, M_{T2,3}, and M_{T1,3} and the respective references R_{T1,2}, R_{T2,3}, and R_{T1,3}. The references R_{T1,2}, R_{T2,3}, and R_{T1,3} may be calculated in particular during a step of initializing the network on the vehicle. Preferably, the network initialization step corresponds to training the network. During this initialization step, each tire of the vehicle is inflated to a predetermined nominal pressure.

When the absolute value of each of two of the indicators λ_{T1,2}, λ_{T2,3}, and λ_{T1,3} exceeds a non-zero threshold ε_{L}, a set of two suspect tires is determined on the basis of these two indicators that exceed in absolute value the non-zero threshold ε_{L}. The threshold ε_{L} is selected in such a manner as to obtain a desired level of sensitivity in detecting insufficient pressure.

In the example shown in FIG. 2, each of the indicators λ_{T1,2} and λ_{T2,3} exceeds in absolute value the threshold ε_{L}. The indicator λ_{T1,3} does not exceed in absolute value the threshold ε_{L}. The set of two suspect tires is thus formed by the two tires carried by the axle that is common to the two indicators λ_{T1,2} and λ_{T2,3}, i.e. the axle T2. The two suspect tires are thus PT2D and PT2G.

Which of the two suspect tires has insufficient pressure is determined from the sign of one of the two indicators λ_{T1,2} and λ_{T2,3} that exceeds, in absolute value, the non-zero threshold ε_{L}.

When using the network 12A on the tractor 14, the inclinometers IT1 and IT2 are adjusted so that if the indicator λ_{T1,2} is positive, then the tires PT1D and PT2G form the set of two suspect tires. Conversely, if the indicator λ_{T1,2} is negative, then the tires PT1G and PT2D form the set of two suspect tires. In analogous manner, the inclinometer IT3 is adjusted so that if λ_{T2,3} is positive, then the tires PT2D and PT3G form the set of two suspect tires and if λ_{T2,3} is negative, then the tires PT2G and PT3D form the set of two suspect tires. Finally, if the indicator λ_{T1,3} is positive then the tires PT1D and PT3G form the set of two suspect tires, and if λ_{T1,3} is negative, then the tires PT1G and PT3D form the set of two suspect tires.

In the example shown in FIG. 3, the sign of λ_{T1,2} is negative, so the deflector tire on axis T2 is the tire PT2D. It should be observed that the defective tire could have been determined from the sign of λ_{T2,3}. Since the sign of λ_{T2,3} is positive, the defective tire on the axle T2 is indeed the tire PT2D.

As shown in FIG. 5, the processor unit UT sends a signal A to the display unit UA. This signal A serves to update a pressure state display concerning the tires of the tractor 14. In the present example, the display unit UA warns the driver of the vehicle that the pressure in a tire, specifically the tire PT2D, is insufficient.

In a variant of the method of monitoring the pressure of the tires of the tractor 14, a set of four suspect tires is determined on the basis of a first one of two indicators λ_{T1,2} and λ_{T2,3} exceeding, in absolute value, the threshold ε_{L}.

Then, in the example shown in FIG. 2, since the indicator λ_{T1,2} exceeds an absolute value the threshold ε_{L}, the tire with insufficient pressure is to be found either on the axle T1 or on the axle T2.

Amongst the set of four tires carried by the axles T1 and T2, the tire in which the pressure is insufficient is determined from the sign of the second of the two indicators that exceed, in absolute value, the non-zero threshold ε_{L}.

Since the sign of λ_{T2,3} is positive, and since the tire with insufficient pressure is either on axle T1 or on axle T2, the tire with insufficient pressure is therefore PT2D.

With reference to FIG. 5, during the second measurement sequence II, each communications unit CO1, CO2, CO3 of each measurement unit U1, U2, U3 sends a respective signal S′1, S′2, S′3 to the processor unit UT, in the same manner as during the first acquisition sequence I. Each signal S′1, S′2, S′3 is represented by a vector V_{T1,2}, V_{T2,3}, V_{T1,3} in which each coordinate is the mean of measurements acquired during the second measurement sequence II. The synchronization signal S′ transmitted at the end of the first acquisition sequence I is earlier than the synchronization signal S″ transmitted at the end of the second acquisition sequence II. The term “earlier” is used to designate the fact that the signal S′ is transmitted before the signal S″.

In this example, after the earlier synchronization signal S′ has been sent, and after the processor unit UT has received one of the signals S′1, S′2, and S′3, the processor unit UT begins a waiting delay Δ_{D}. Preferably, the reception signal from which the processor unit begins the waiting delay Δ_{D} is the first signal received after transmitting the earlier synchronization signal S′, and specifically the signal S′1. If the processor unit UT does not receive the signals S′2 and/or S′3 within the predetermined waiting delay Δ_{D}, then the synchronization signal S″ is transmitted.

Under such circumstances, the processor unit UT does not send the signal A to the display unit.

There follows a description of the network 12B constituting the second embodiment of the invention (the network for the trailer 16). In this network, elements that are analogous to those of the network 12A are designated by references that are identical.

The network 12B constituting the second embodiment comprises first and second nodes forming respective first and second measurement units U1 and U2. In addition, the network 12B has the same display unit UA as the network 12A. The display unit UA is connected to the processor unit UR of the network 12B. As in the network 12A, the first and second measurement units U1 and U2 comprise respective first and second inclinometers IR1 and IR2 carried by the first and second axles R1 and R2. The inclinometers IR1 and IR2 are preferably of the electrolytic type.

As in the network 12A, each inclinometer IR1 and IR2 is suitable for measuring, relative to the longitudinal direction, an angle of inclination of the axis of the axle carrying the inclinometer as measured about an inclination axis IRL that is parallel to the longitudinal direction of the trailer 16.

Nevertheless, in the network 12B, each inclinometer IR1, IR2 is designed also to measure, relative to a second direction, an angle of inclination a of the axis of the axle carrying the inclinometer about an axis of inclination IRT parallel to said second direction. In the example shown in FIGS. 1, 7, and 9, the second direction corresponds substantially to a direction that is transverse relative to the vehicle, parallel to the Y axis.

As shown in greater detail in FIG. 7, the trailer 16 has two guide arms 40 and 42 connecting the axles R1 and R2 respectively to the chassis. Each guide arm 40 and 42 connects each axle R1 or R2 to a transverse pivot axis 44 or 46 that is connected to the chassis of the trailer 16. Specifically, each guide arm 40 and 42 is formed by half a spring blade. Each guide arm could also make use of multiple arms. In this way, the axle axes AR1 and AR2 are suspended and substantially parallel to the respective pivot axes 44 and 46. Each of the axes AR1 and AR2 can thus oscillate about the corresponding axis 44 or 46. Each of the axes 44 and 46 thus forms the inclination axis IRT for the corresponding inclinometer IR1 or IR2 carried by each of the suspend axles R1 and R2, which inclination axis IRT is parallel to the direction extending transversely to the trailer.

The network 12B of the trailer 16 serves to monitor the pressure of the tires of the trailer 16 in application of a monitoring method having its principle steps described below.

The calculation unit CAT of the processor unit UR calculates the first and second inclination histories VL1 and VL2, relating to the longitudinal direction of the trailer, the vectors being made up of the angles of inclination relative to said longitudinal direction of the first and second axle axes AR1 and AR2. In this second embodiment, first and second inclination histories VT1 and VT2 are also calculated relative to the direction that extends transversely to the trailer, using angles of inclination, relative to said transverse direction, of the first and second axle axes AR1 and AR2.

Unlike the method of monitoring tire pressures in the tractor 14, the first measurement unit U1 acquires angle measurements for the first axle AR1 that are relative both to the longitudinal direction and to the transverse directions. The second measurement unit U2 acquires angle measurements relative to both the longitudinal and the transverse directions for the second axle axis AR2.

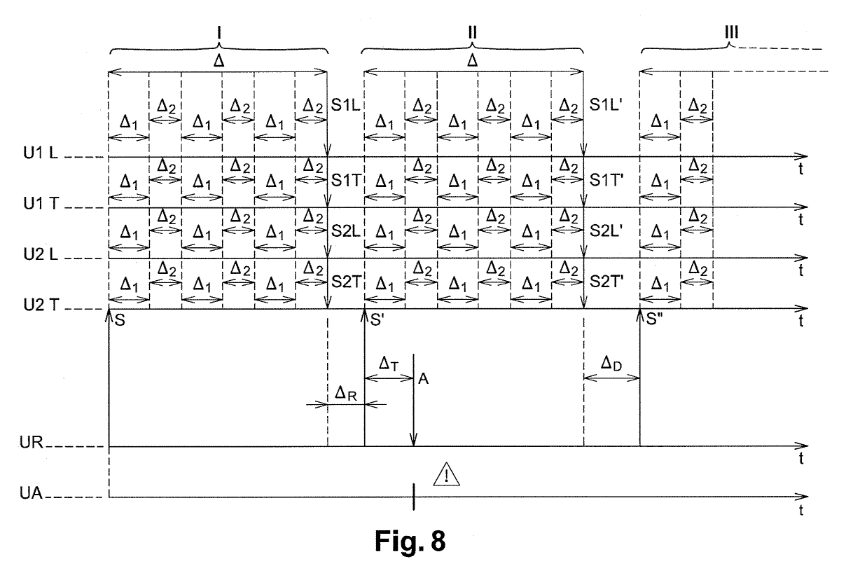

The network 12B of the trailer 16 is managed in a manner analogous to managing the network 12A. Thus, FIG. 8 shows the acquisition sequences of each of the units U1 and U2 relative to the longitudinal direction on lines U1L and U2L. It also shows the acquisition sequences of each unit U1 and U2 relative to the transverse direction respectively on lines U1T and U2T. During each acquisition step, each measurement unit U1 and U2 acquires n₀ measurements for each angle relative to each of the longitudinal and transverse directions, and then calculates each image of the n₀ measurements in application of the function F.

Thus, the calculation unit CA1 calculates a measurement vector forming the inclination history VL1 of the angle of inclination of the first axle axis AR1 relative to the longitudinal direction and a measurement vector forming the inclination history VT1 of the angle of inclination of the first axle axis AR1 relative to the transverse direction. In analogous manner, the calculation unit CA2 calculates a measurement vector forming the inclination history VL2 of the angle of inclination of the second axle axis AR2 relative to the longitudinal direction and a measurement vector forming the inclination history VT2 of the angle of inclination of the second axle axis AR2 relative to the transverse direction.

In analogous manner, the measurement signals S1L, S1T, S2L, and S2T are transmitted representing the measurement vectors respectively forming the inclination histories VL1, VT1, VL2, and VT2.

After the signals S1L, S1T, S2L, and S2T have been received by the processor unit UR, a deflection vector relative to the longitudinal direction is calculated and given reference V_{R}. A deflection vector is also calculated relative to the transverse direction from the first and second inclination histories VT1 and VT2 relative to the transverse direction, and given the reference P_{R}. In a manner analogous to the notation used for the vectors V_{R}, the reference P_{Ri,j} designates the deflection vector calculated from the inclination histories relative to the transverse direction for the angles of the axle axes i and i.

The steps of calculating the deflection-indicators of the network 12B can be derived mutatis mutandis from the steps for the network 12A. In particular, the deflection vector V_{R1,2} relating to the longitudinal direction, the deflection vector P_{R1,2} relating to the transverse direction, the enriched deflection vector VE_{R1,2} relating to the longitudinal direction, the enriched deflection vector PE_{R1,2} relating to the transverse direction, the culled deflection vector TR_{1,2} relating to the longitudinal direction, the culled deflection vector PT_{R1,2} relating to the transverse direction, the arithmetic mean M_{R1,2} relating to the longitudinal direction, arithmetic mean PM_{R1,2} relating to the transverse direction, the indicator τ_{R1,2} relating to the transverse direction, and the indicator λ_{R1,2} relating to the longitudinal direction are all calculated.

In the event of a tire of the trailer 16 having insufficient pressure, the axis of the axle carrying the tire with insufficient pressure forms respective angles about the inclination axes IRL and IRT that are parallel to the longitudinal and transverse directions respectively of the trailer 16.

When the indicator relative to the longitudinal direction λ_{R1,2} exceeds, in absolute value, the non-zero threshold ε_{L} relating to the longitudinal direction, and when the indicator relative to the transverse direction τ_{R1,2} exceeds in absolute value a non-zero threshold ε_{T} relating to the transverse direction, a set of two suspect tires is initially determined on the basis of the sign of one of the two indicators, referred to as the first reference indicator, that exceeds in absolute value the corresponding threshold ε_{L} or ε_{T}.

Specifically, the first reference indicator is the indicator λ_{R1,2} relating to the longitudinal direction of the vehicle.

In the embodiment shown in FIG. 7, the set of two suspect tires thus comprises two tires that are transversely opposite and carried by two different axles. Specifically, since λ_{R1,2} is positive the set comprises the tires PR1D and PR2G.

Which one of the tires in the set of two suspect tires PR1D and PR2G has insufficient pressure is determined from the sign of the second reference indicator P_{R1,2} exceeding, in absolute value, the corresponding threshold ε_{T}.

During installation of the network 12B on the trailer 16, the inclinometers IR1 and IR2 are adjusted in a manner analogous to the inclinometers IT1 and IT2. In addition, the inclinometers IR1 and IR2 are adjusted so that if the indicator P_{R1,2} is positive, then the tires PR2D and PR2G form the set of two suspect tires. Conversely, if the indicator τ_{R1,2} is negative, then the tires PR1G and PR1D form the set of two suspect tires.

In the example described, τ_{R1,2} is positive, so the defective tire is the tire PR2G, as shown in FIG. 7.

In a variant of the method of monitoring tire pressures of the trailer 16, the first reference indicator is the indicator τ_{R1,2} relative to the transverse direction and the second reference indicator is the indicator λ_{R1,2} relative to the longitudinal direction.

The set of two suspect tires thus comprises two transversely-opposite tires carried by the same axle. Specifically, since τ_{R1,2} is positive, the two suspect tires are the tires carried by the axle R2.

In addition, since λ_{R1,2} is positive, the tire with insufficient pressure is the tire PR2G.

FIG. 9 shows a heavy goods type vehicle 10 having two networks in accordance with third and fourth embodiments of the invention and given respective references 12A′ and 12B′. Elements analogous to those of the networks 12A and 12B of the first and second embodiments are designated by references that are identical.

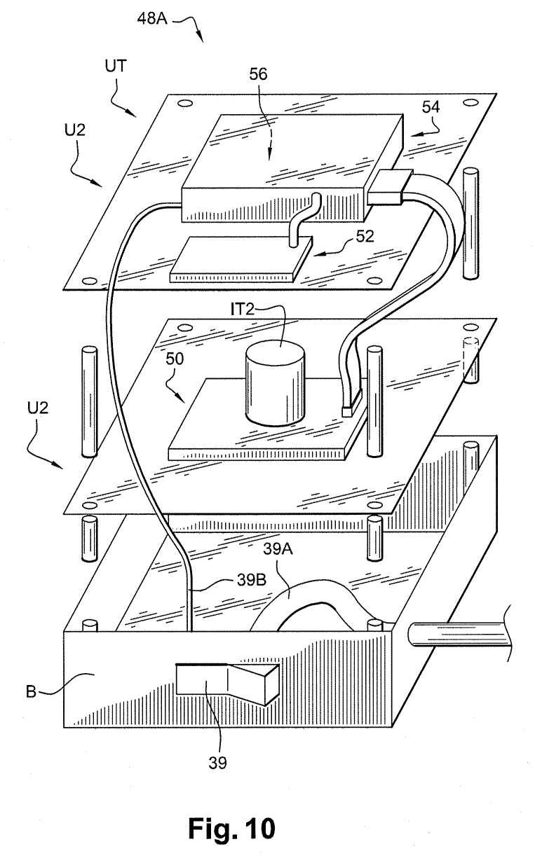

Unlike the first and second embodiments, each network 12A′ and 12B′ comprises a box 48A and 48B (shown in FIG. 10) for fitting to an axle of the vehicle 14, 16. Each box 48A and 48B contains a respective combined unit U2M or U1M. The combined unit U2M comprises the measurement unit U2 of the network 12A together with the processor unit UT of the network 12A. The combined unit U1M comprises the measurement unit U1 of the network 12B and the processor unit UR of the network 12B. With reference to FIG. 10, which shows the box 48A, it can be seen that the box 48A contains a sensor 50, specifically an inclinometer IT2, a communications unit 52, and a common calculation unit 54.

In the network 12A′, respectively 12B′, the sensor 50 of the measurement unit U2, respectively U1, is connected to the calculation unit 54. This calculation unit 54 comprises a microcontroller 56 constituting both the microcontroller 38 of the processor unit UT, respectively UR, and the microcontroller of the measurement unit U2, respectively U1. Thus, the measurement unit U2, respectively U1, does not necessarily include a communications module for communication with the corresponding processor unit UT, respectively UR. The communications unit 52 forms the communications unit COT of the corresponding processor unit UT, respectively UR.

The networks 12A′ and 12B′ serve to monitor the tire pressures respectively of the tractor 14 and of the trailer 16.

Nevertheless, unlike the above-described pressure monitoring methods, the measurement unit U2 or U1 does not transmit a measurement signal to the corresponding processor unit UT or UR. The microcontroller 56 that is common to the processor unit and to the measurement unit calculates the measurement vector VL2 (tires of the tractor 14) and the measurement vectors VL1 and VT1 (tires of the trailer 16).

In addition, the microcontroller 56 sends the synchronization signal S′ directly to the sensor IT2 or IR1 to which it is connected.

The invention is not limited to the above-described embodiments.

The synchronization signal may be transmitted by the processor unit at any time after receiving the measurement signals transmitted by the measurement units. In particular, the synchronization signal could be transmitted after the measurement signals have been processed by the processor unit.

In addition, the communications unit COT of the processor unit of the tractor network can be suitable for receiving the signal A transmitted by the communications unit COT of the processor unit of the trailer network. In this way, the communications unit COT of the tractor network processor unit serves to relay the signal A in the event that the processor unit of the trailer network is too far away from the display unit UA.

Each measurement unit may be powered electrically in a manner that is independent from the other measurements unit by means of a respective battery.

In addition, the network 12B may also include an additional display unit arranged on the trailer 16 and visible from the driver's cabin of the tractor 14. This additional display unit comprises a communications unit suitable for receiving the signal A transmitted by the communications unit of the processor unit of the network 12B. The additional display unit also includes alarm means, e.g. a lamp that is designed to be switched on in the event of a tire of the trailer 16 being found to have insufficient pressure.

The processor unit may also provide other functions, for example functions of managing the vehicle braking or of controlling the path followed by the vehicle. Thus a processor unit serves to reduce the number of nodes making up the various networks mounted on the vehicle.

What is claimed is:

1. A method of managing a network of sensors, the network comprising:
at least two nodes, each forming a measurement unit including a sensor; and
a node forming a processor unit to which the measurement units are connected;
each measurement unit being designed to acquire measurements and to transmit to the processor unit a signal that is a function of said measurements, and referred to as a measurement signal; measurement acquisition sequences performed by the measurement units are mutually synchronized by means of a synchronization signal transmitted by the processor unit to each of the measurement units.

2. The method according to claim 1, wherein a synchronization signal is transmitted after the processor unit has received measurement signals transmitted by all of the measurement units.

3. The method according to claim 1, wherein a synchronization signal is transmitted in the event of the processor unit not receiving an expected measurement signal from a measurement unit within a predetermined waiting delay.

4. The method according to claim 3, wherein, after an earlier synchronization signal has been transmitted before said synchronization signal, the waiting delay begins after the transmission of the earlier synchronization signal, when the processor unit receives a measurement signal that is preferably the first signal it receives after transmission of the earlier synchronization signal.

5. The method according to claim 1, wherein at least one measurement signal is represented by a vector having a plurality of coordinates and referred to as a measurement vector.

6. The method according to claim 5, wherein each coordinate of the measurement vector is an image obtained by applying a function to n₀ measurements, n₀ being a non-zero integer and the function preferably being an arithmetic mean of the n₀ measurements.

7. The method according to claim 6, wherein each measurement acquisition sequence comprises nₑ steps of acquiring n₀ measurements alternating with nₑ steps of calculating the image of said n₀ measurements by applying the function, where nₑ is a non-zero integer.

8. The method according to claim 5, wherein the measurement signal is transmitted after coordinates have been stacked in a stack forming part of storage means of the measurement unit and after the stack reaches a number of coordinates that is equal to the number of coordinates of the vector.

9. The method according to claim 5, wherein the processor unit calculates differences between the coordinates of two measurement vectors transmitted by two distinct respective measurement units.

10. A network of sensors, the network being of the type comprising:
at least two nodes, each forming a measurement unit including a sensor; and
a node forming a processor unit to which the measurement units are connected;
each measurement unit including a communications unit having transmission means suitable for transmitting at least one measurement signal, the processor unit including a communications unit including reception means suitable for receiving each of the measurement signals as transmitted by each measurement unit; the processor unit includes synchronization means for synchronizing measurement acquisition sequences by the measurement units, the communications unit of the processor unit including transmission means suitable for transmitting a synchronization signal, and the communications unit of each measurement unit including reception means suitable for receiving the synchronization signal.

11. The network according to claim 10, wherein the communications unit of the processor unit is formed by a radio communications module suitable for operating an application of a standard of the IEEE 802.15.4 type.

12. The network according to claim 10, wherein the communications unit of each measurement unit is formed by a radio communications module suitable for operating in application of a standard of the IEEE 802.15.4 type.

13. The network according to claim 10, wherein the communications unit of the processor unit is formed by a wired-bus communications module suitable for operating with a CAN type protocol.

14. The network according to claim 10, wherein the communications unit of each measurement unit is formed by a wired-bus communications module suitable for operating in application of a CAN type protocol.

15. The network according to claim 10, wherein each measurement unit includes a calculation unit that preferably comprises a microcontroller.

16. The network according to claim 10, wherein the synchronization means comprise a microcontroller.

17. The network according to claim 10, wherein the processor unit includes a calculation unit preferably comprising a microcontroller.

18. The network according to claim 16, wherein the processor unit includes a calculation unit preferably comprising a microcontroller, and the processor unit comprises a microcontroller constituting both the microcontroller of the synchronization means and the microcontroller of the calculation unit of the processor unit.

19. The network according to claim 18, wherein each measurement unit includes a calculation unit that preferably comprises a microcontroller and the network includes a microcontroller forming both the microcontroller of the processor unit and the microcontroller of a measurement unit.

20. A vehicle provided with a network according to claim 10 for monitoring the pressure of the tires of the vehicle.

21. The vehicle according to claim 20, wherein each sensor comprises an inclinometer carried by an axle of the vehicle and serving to measure an angle of inclination of the axle axis relative to a direction about an inclination axis that is parallel to said direction, which inclinometer is preferably of the electrolytic type.

22. The vehicle according to claim 20, including an electricity source suitable for powering, amongst other members of the vehicle, at least one of the measurement units.

23. The vehicle according to claim 20, including a box suitable for fitting on an axle of the vehicle, the box containing the processor unit and a measurement unit.
